(19) United States
(12) Patent Application Publication
(10) Pub. No.: US 2024/0423122 A1
(43) Pub. Date: Dec. 26, 2024

(54) Lawn Mower and Lawn Mower Speed Control Method

(71) Applicant: KAWASAKI MOTORS, LTD., Akashi-shi (JP)

(72) Inventors: Hiroyuki KATAOKA, Akashi-shi (JP); Hirokazu MORITA, Akashi-shi (JP); Tomotaka NAKAGAWA, Akashi-shi (JP)

(21) Appl. No.: 18/339,562

(22) Filed: Jun. 22, 2023

(51) Int. Cl. A01D 34/00; A01D 34/64; A01D 34/86; G05D 1/246; G05D 1/606; G05D 1/65

(52) U.S. Cl. CPC A01D 34/006; A01D 34/64; A01D 34/86; G05D 1/246; G05D 1/606; G05D 1/65; A01D 69/02; A01D 2101/00; G05D 2105/15; G05D 2107/23

(57) ABSTRACT

A lawn mower 10 of the present embodiment travels on a lawn and cuts grass. The lawn mower 10 includes a drive source 12 and a controller 21. The drive source 12 generates power for the lawn mower 10 to travel. The controller 21 receives height at each position of the lawn from a sensor that detects the height at each position of the lawn or from a memory (a storage of the controller 21, a laptop PC 40, or a server) that stores the height at each position of the lawn and controls the drive source 12 based on a height change in the lawn in front in a travel direction to change a travel speed.

### TECHNICAL FIELD

The present application mainly relates to a lawn mower that travels on a lawn and cuts grass.

### BACKGROUND ART

PTL 1 is U.S. patent publication No. 2016/0037718.
PTL 1 discloses a lawn mower. The lawn mower operates a mower blade to cut grass while traveling.

### SUMMARY OF THE INVENTION

A lawn that a lawn mower mows may be in a diverse condition. Therefore, it is preferable to mow a lawn in a way suitable to the lawn to be mowed.

The present application is made in view of the situation described above, and its main purpose is to provide a lawn mower that can mow lawns in a way suitable for each lawn.

### Means for Solving the Problems

The problem to be solved by the present application is as described above. The means to solve this problem and the effects thereof will be described below.

A first aspect of the present application provides a lawn mower with a configuration described below. That is, the lawn mower travels on a lawn and cuts grass. The lawn mower includes a drive source and a controller. The drive source generates power for the lawn mower to travel. The controller receives height at each position of the lawn from a sensor that detects the height at each position of the lawn or from a memory that stores the height at each position of the lawn and controls the drive source based on a height change in the lawn in front in a travel direction to change a travel speed.

A second aspect of the present application provides a lawn mower with a configuration described below. That is, a lawn mower travels on a lawn and cuts grass. The lawn mower includes a drive source and a controller. The drive source generates power for the lawn mower to travel. The controller controls the drive source and sets a first speed range or a second speed range that includes a speed higher than a maximum speed in the first speed range and does not include a speed lower than a minimum speed in the first speed range based on information about surroundings of the lawn mower received from a sensor or a memory.

A third aspect of the present application provides a travel control method as follows. That is, the method includes receiving information about surroundings of a lawn mower from a sensor or a memory. The method includes setting a first speed range or a second speed range that includes a speed higher than a maximum speed in the first speed range and does not include a speed lower than a minimum speed in the first speed range based on the information about the surroundings of the lawn mower received. The method includes controlling a drive source based on the first speed range or the second speed range set to make the lawn mower to travel.

### Effects of the Invention

According to the present application, a lawn mower that can mow lawns in a way suitable for each lawn can be accomplished.

### BRIEF DESCRIPTION OF THE DRAWINGS

FIG. 1 is a block diagram of a lawn mower and a laptop PC.

FIG. 2 is a flowchart illustrating control to change a travel speed of a lawn mower based on the height of a lawn in front of the lawn mower and control to change a rotational speed of a mower blade.

FIG. 3 is a graph illustrating a first mode, a second mode, a first speed range, and a second speed range.

FIG. 4 is an illustrative drawing showing that an uncut area occurs due to a lawn mower lifting off the ground at a time when slope angle decreases.

FIG. 5 is an illustrative drawing showing that reducing a travel speed before reaching a starting point of height change restrains a lawn mower from leaving too far from the ground and causes no uncut area.

FIG. 6 is a flowchart illustrating control to change a travel speed of a lawn mower based on height of a lawn in front of the lawn mower.

FIG. 7 is an illustrative drawing showing that an unintentional decrease in a travel speed of a lawn mower occurs due to an increase of slope angle of a lawn.

FIG. 8 is an illustrative drawing showing that increasing a travel speed before reaching a starting point of height change restrains the travel speed of a lawn mower from decreasing.

FIG. 9 is an illustrative drawing showing a travel speed being reduced before reaching an uneven area.

FIG. 10 is a flowchart illustrating a process of reducing a travel speed based on a location of an uneven area.

FIG. 11 is an illustrative drawing showing a travel route being revised based on height of a lawn in front of a lawn mower.

FIG. 12 is a flowchart illustrating a process of creating or revising a travel route based on height of a lawn in front of a lawn mower.

FIG. 13 is an illustrative drawing showing a travel speed being changed depending on whether a lawn mower is turning, travelling on a boundary, or travelling on a slope.

FIG. 14 is a flowchart illustrating a process of changing a travel speed depending on whether a lawn mower is turning, travelling on a boundary, or travelling on a slope.

FIG. 15 is a flowchart illustrating control to change a travel speed of a lawn mower based on information about surroundings of the lawn mower and control to change a rotational speed of a mower blade.

### EMBODIMENT FOR CARRYING OUT THE INVENTION

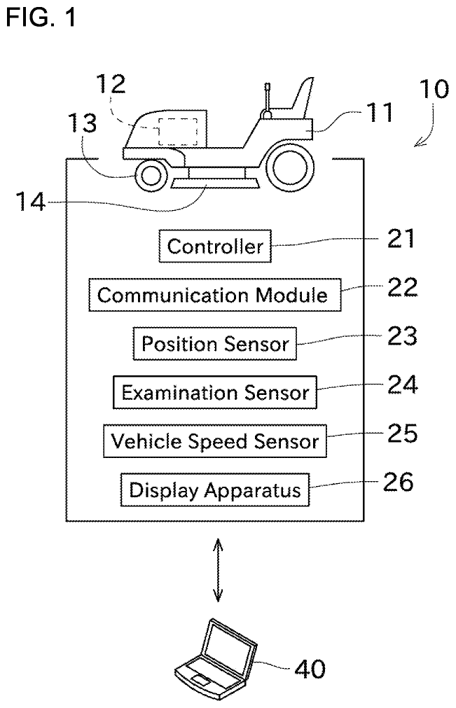

First, with reference to FIG. 1, a configuration of a lawn mower 10 of the present embodiment will be described below. The lawn mower 10 mows a lawn. Lawn mowing is an act of cutting grass growing on the lawn. The lawn mower 10 is self-propelled.

Lawns to be mowed exist at various locations. For example, a lawn exists in a residential yard, an institutional open space, a park, or a golf course. Depending on a lawn to be mowed, the condition of the lawn, especially the difference of the height within the lawn varies. For example, the lawn may include a raised area around a tree, a slope for drainage, an undulation made for landscaping, and a natural undulation. Therefore, the heights of areas in the lawn are different from each other.

In addition, the lawn is an area where grass under cultivation is growing. In contrast, a grassland is an area that is mainly composed of weeds. Besides, as for the lawn, landscaping by the grass is important. On the other hand, landscaping is not so important for the grassland. Therefore, lawn mowing should be done in such a way that the condition of the grass is kept under the cultivation and that the lawn is landscaped. In other words, the purpose of lawn mowing is not to simply remove grass but to conduct maintenance on the grass and to landscape the lawn. In contrast, since the purpose of mere cutting grass is removal of the weeds only, landscaping or condition of the grass is not considered. Therefore, in lawn mowing, it is preferable to shorten an operating time while emphasizing the quality of the operation in consideration of landscaping and condition of the grass.

The lawn mower 10 includes a vehicle body 11. The vehicle body 11 includes a frame and a body. A drive source 12, wheels 13, and a mower blade unit 14 are installed to the vehicle body 11.

The drive source 12 is a gasoline engine. The drive source 12 generates power by burning gasoline as fuel. The power generated by the drive source 12 is transmitted to the wheels 13. In this manner, the lawn mower 10 moves. The engine is not limited to a gasoline engine, but may be an engine that runs on ethanol, a gas engine, or a diesel engine. The drive source 12 may be an electric motor or may be comprised of both an engine and an electric motor. The drive source 12 may further include a transmission for travelling.

The wheels 13 are provided in pairs on the right and left sides and are arranged side by side on the front and the rear sides. Although the lawn mower 10 of the present embodiment includes four wheels 13, the number of the wheels 13 may be other than four. In the present embodiment, only the rear wheels steer the lawn mower 10. However, both the front wheels and the rear wheels may steer the lawn mower 10. Alternatively, only the front wheels may steer the lawn mower 10. A mechanism that allows the right and left wheels to change directions independently may be included. Instead of the wheels 13, the lawn mower 10 may travel by crawler tracks or the like.

The mower blade unit 14 includes a rotary mower blade. The power generated by the drive source 12 is transmitted to the mower blade unit 14. In this manner, the mower blade of the mower blade unit 14 rotates and cuts the grass. The configuration that transmits the power from the drive source 12 to the mower blade unit 14 includes a speed changer for the mower blade that changes the rotational speed of the mower blade. This allows the rotational speed of the mower blade to be varied. Although the drive source for travelling and operating the mower blade unit 14 are the same in the present embodiment, drive sources for traveling and operating the mower blade unit 14 may be provided separately. In lawn mowing, it is important to cut the grass uniformly to a predetermined length. Therefore, the mower blade unit 14 may include a configuration to adjust the cutting height. The mower blade unit 14 may also include a component that stands the lying grass up. A mechanism for discharging cut grass by blowing may be provided at the mower blade unit 14 or close to the mower blade unit 14.

The lawn mower 10 includes a steering lever and a seat. An operator sits on the seat of the lawn mower 10 and operates the steering lever. The lawn mower 10 may be configured in such a way that the operator stands on the lawn mower 10. The lawn mower 10 may include a steering wheel instead of the steering lever. The lawn mower 10 may be configured to be remotely operated by the operator. The lawn mower 10 may be configured to be autonomous so that it does not require operation of the operator. Accordingly, the steering tool and the seat of the lawn mower 10 are not absolutely required and may be omitted.

As described below, the lawn mower 10 of the present embodiment has features related to speed control. Therefore, no matter which type described above of the lawn mower 10 is, it is preferable that the lawn mower 10 has a mode where the travel speed is controlled by a machine. For example, the lawn mower 10 may control the travel speed all the time or the lawn mower 10 may be configured to control the travel speed only when authorized by the operator. As for steering, there is no limitation, so the lawn mower 10 may control the steering all the time, the lawn mower 10 may be configured to control the steering only when authorized by the operator, or the operator may steer the lawn mower 10 all the time.

The lawn mower 10 includes a controller 21. The controller 21 is an engine control unit that controls the drive source 12. More specifically, the controller 12 is an electronically controlled fuel injection apparatus. Specifically, the controller 21 is a microcomputer that includes a CPU, a main memory, and storage. The CPU loads a program and control data stored in the storage into the main memory and executes it. In this manner, the controller 21 performs control to vary the travel speed of the lawn mower 10. Specifically, the controller 21 performs control related to fuel injection. For example, the controller 21 performs the control to maintain a predetermined rotational speed of the engine. Specifically, the controller 21 electronically controls the fuel infection. So the controller 21 can respond to the increased engine load early when the engine load increases. The controller 21 can also vary the rotational speed of the mower blade by controlling the speed changer for the mower blade as described above.

If the drive source 12 includes an electric motor, the controller 21 may perform control to vary the motor current. If the drive source 12 includes the transmission for travelling, the controller 21 may perform control to shift gears. If the drive sources for travelling and operating the mower blade unit 14 are provided separately, the controller 21 may control both drive sources alone, or two controllers, one for the drive source for travelling and another for the drive source for operating the mower blade unit 14, may be provided separately. When this is the case, the controller for the drive source for travelling may vary the travel speed by changing the rotational speed of the drive source for travelling.

The lawn mower 10 includes a communication module 22. The communication module 22 is a wireless communication module and performs wireless communication based on instructions from the controller 21. Specifically, the communication module 22 performs proximity wireless communication using a wireless communication circuit and an internal antenna or an external antenna. This allows the communication module 22 to communicate with a smartphone, a tablet PC, a laptop PC or the like. FIG. 1 shows a laptop PC 40, which is an example of an apparatus that the lawn mower 10 communicates with. The communication module 22 may be able to directly connect to the Internet. The communication module 22 may be a wired communication module.

The lawn mower 10 includes a position sensor 23, an detection sensor 24, and a vehicle speed sensor 25. The position sensor 23 is a GNSS sensor and includes a GNSS antenna and a GNSS receiver. The GNSS receiver calculates the latitude and longitude of the position of the lawn mower 10 based on signals received by the GNSS antenna from satellites. The detection sensor 24 is a sensor that examines the surroundings of the lawn mower 10, especially the front of the lawn mower 10, to detect the height of the lawn. The height of the lawn does not mean the length of the grass, but means the height of the surface of the lawn, in other words, the height of the grand on which the lawn mower 10 travels. Strictly speaking, the position or the height detected by the sensors is information that indicates the position or the height. The detection sensor 24 is, for example, a LiDAR, an ultrasonic sensor, a radar apparatus, or a camera. The LiDAR, the ultrasonic sensor, and the radar apparatus examines the surroundings of the lawn mower 10 by emitting detection signals and analyzing reflected waves. The camera examines the surroundings of the lawn mower 10 by analyzing an acquired image. The vehicle speed sensor 25 is a sensor that is installed at a shaft member of the drive source 12 or a shaft member of the wheels 13, for example, and detects a rotational frequency of the shaft member. Based on the rotational frequency per unit of time, the travel speed of the lawn mower 10 can be calculated. The position of the lawn detected by the detection sensor 24 is a relative position with respect to the lawn mower 10. The absolute position of the lawn mower 10 can be identified by the position sensor 23. Therefore, by combining the results of the detection made by the position sensor 23 and the detection sensor 24, the absolute position of the lawn can be identified. Alternatively, the detection sensor 24 may detect the distance to the ground in front of the lawn mower 10 in a predetermined direction. For example, if the detected distance decreases with time, it can be determined that the lawn mower 10 is approaching an uphill slope. If the detected distance increases with time, it can be determined that the lawn mower 10 is approaching downhill slope. The results of the detection made by the position sensor 23, the detection sensor 24, and the vehicle speed sensor 25 can be output to the controller 21. The lawn mower 10 may include a gyroscope sensor. The gyroscope sensor is a triaxial angular velocity sensor and detects the angular velocities with respect to three axes of the lawn mower 10. The posture of the lawn mower 10 can be detected based on the results of the detection made by the gyroscope sensor. The posture of the lawn mower 10 can be used to modify the relative position or the height of the lawn that is detected by the detection sensor 24.

The lawn mower 10 includes a display apparatus 26. The display apparatus 26 is a liquid crystal display or an organic EL display and is capable of displaying an image generated by the controller 21. The display apparatus 26 is arranged, for example, at a location corresponding to the seat and the operator seated in the seat can see it. However, the display apparatus 26 may be positioned as desired and may be arranged anywhere at the lawn mower 10. The display apparatus 26 is not an essential component and may be omitted.

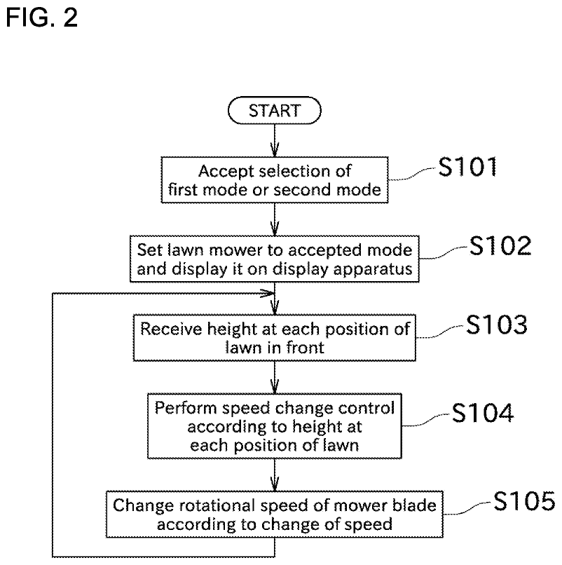

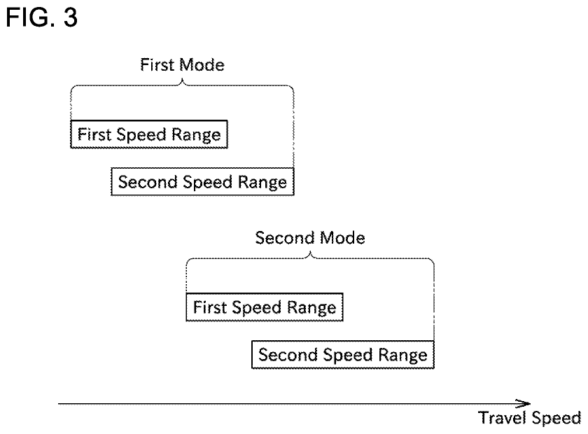

Next, the control performed by the controller 21 will be described in detail below. First, with reference to FIG. 2 and FIG. 3, an overview of the control to change the travel speed of the lawn mower 10 based on the height of the lawn in the front and the control to change the rotational speed of the mower blade will be described below.

The lawn mower 10 of the present embodiment can be set to a first mode or a second mode shown in FIG. 3 as the mode of control for changing the travel speed. As shown in FIG. 3, the travel speed set in the second mode tends to be higher than the travel speed set in the first mode. For example, the maximum speed that can be set in the second mode is higher than the maximum speed that can be set in the first mode. For example, the average of the travel speeds that can be set in the second mode is higher than the average of the travel speeds that can be set in the first mode. Basically, there is a trade-off between the travel speed of the lawn mower 10 and the quality of the operation of lawn mowing. The operation of good quality is to cut the grass in such a way that good growing condition is maintained, i.e. to achieve a cutting surface of good quality. Alternatively, the operation of good quality is to cut the grass in order not to leave much grass uncut. For example, when the speed of relative rotation of the mower blade with respect to the grass is high, the quality of the cutting surface of the grass tends to be good. However, if the travel speed is excessively high or the amount of the grass to be cut is large, the speed of relative rotation of the mower blade with respect to the grass becomes low. As a result, the quality of the cutting surface of the grass becomes low, and the quality of the operation becomes low. If the travel speed is excessively high, the grass is more likely to be left uncut. Therefore, the operator selects the first mode when the quality of the operation takes priority over the operating time. The operator selects the second mode when the operating time takes priority over the quality of the operation.

In the first mode, either a first speed range or a second speed range can be set. The second speed range includes a speed higher than a maximum speed in the first speed range and does not include a speed lower than a minimum speed in the first speed range. In the second mode, similarly to that in the first mode, either a first speed range or a second speed range can be set. The controller 21 selects either the first speed range or the second speed range based on the condition of the surroundings of the lawn mower 10, the route that the lawn mower 10 travels, and other factors. The controller 21 sets a speed within the selected first or second speed range and controls the drive source 12 in such a way that the lawn mower 10 travels at the set speed.

As shown in FIG. 2, the controller 21 accepts a selection of the first mode or the second mode (S101). For example, the controller 21 displays a mode selection screen on the display apparatus 26. The operator selects the first mode or the second mode displayed on the display apparatus 26 using an operating apparatus or the like. The controller 21 sets the lawn mower 10 to the accepted mode and displays it on the display apparatus 26 (S102). The method of selecting the first mode and the second mode described above is disclosed just as an example. For example, the mode selection screen may be displayed on the laptop PC 40 and the mode selection may be performed via the laptop PC 40. The mode selection is not an essential process and may be omitted.

Then, the lawn mower 10 receives the height at each position of the lawn in the front (S103). In the present embodiment, the results of the detection made by the detection sensor 24 corresponds to the information that indicates the height at each position of the lawn in the front. The height at each position of the lawn is information about the position and the height of the lawn linked to each other. This information is, for example, information that describes the height of each area which the lawn in front of the lawn mower 10 is divided into in a predetermined number according to the distance from the lawn mower 10. The height may be the relative heights with respect to the present height of the lawn mower 10 or may be the absolute height with respect to an unchanging reference height.

In the present embodiment, the height at each position of the lawn in front is detected in real time, in other words, while travelling by using the detection sensor 24. Alternatively, the height at each position of the lawn may be measured in advance and stored in a communication apparatus such as the laptop PC 40. The method of preliminarily measuring the height at each position of the lawn is, for example, to travel or fly over the lawn using a sensor that detects the position and a sensor that detects the height. The sensor that detects the position is a GNSS sensor. The sensor that detects the height is an detection sensor or a GNSS sensor. In this case, the controller 21 receives information that indicates the heights at all positions of the lawn to be mowed from the laptop PC 40 before starting lawn mowing. The controller 21 identifies the height at each position of the lawn in front of the lawn mower 10 based on the position of the lawn mower 10 detected by the position sensor 23 and the height at each position of the lawn received from the laptop PC 40. If the controller 21 and the laptop PC can communicate with each other in real time, the process as follows may be performed. That is, the controller 21 transmits the position of the lawn mower 10 detected by the position sensor 23 to the laptop PC 40. Based on the position of the lawn mower 10 received, the laptop PC 40 retrieves the height at each position of the lawn in front of the lawn mower 10 at the received position and transmits them to the controller 21. The laptop PC 40 may transmit the heights at each position of the entire lawn at once or may transmits the height at each position of a part of the lawn. A part of the lawn is, for example, a part of the lawn that is in front of the lawn mower 10 at the present position. The memory for storing the height at each position of the lawn is not limited to the laptop PC 40. It may be a storage installed at the lawn mower 10 or it may be a server connected to the controller 21 via the Internet.

Then, the controller 21 performs speed change control according to the height at each position of the lawn (S104). The speed change control is a process of changing the travel speed of the lawn mower 10 according to the height at each position of the lawn in front of the lawn mower 10. When the height at each position of the lawn is preliminarily measured and stored as described above, the controller 21 loads the information stored and performs the speed change control according to the height at each position of the lawn. The speed determined in the speed change control may be generated by using a rule-based system or by using a model constructed by machine learning. When using a model, for example, the model may be constructed by supervised learning with respect to the height at each position of the lawn and the appropriate travel speed. The speed change control will be described in detail below.

Then, the controller 21 changes the rotational speed of the mower blade according to the change of the travel speed made by the speed change control (S105). When the travel speed of the lawn mower 10 is increased, the amount of work done by the mower blade unit 14 (the rotational frequency of the mower blade) per unit of area may decrease. Therefore, the controller 21 increases the rotational speed of the mower blade when it performed a process of increasing the travel speed of the lawn mower 10. This allows the quality of the operation of lawn mowing to be maintained high. Alternatively, the controller 21 may decrease the rotational speed of the mower blade when it performed a process of increasing the travel speed of the lawn mower 10. On the other hand, when the travel speed of the lawn mower 10 is decreased, the amount of work done by the mower blade unit 14 per unit of area may increase. Therefore, the controller 21 decreases the rotational speed of the mower blade when it performed a process of decreasing the travel speed of the lawn mower 10. This allows the operating time to be shortened while the quality of the operation of lawn mowing being maintained. The controller 21 may change the rotational speed of the mower blade regardless of the travel speed. The rotational speed of the mower blade may also be constant.

Next, multiple examples for the speed change control will be described below. The lawn mower 10 may perform all of the speed change control described below or may perform only one of them. The lawn mower 10 may also be configured in a way that it can switch multiple speed change controls to perform.

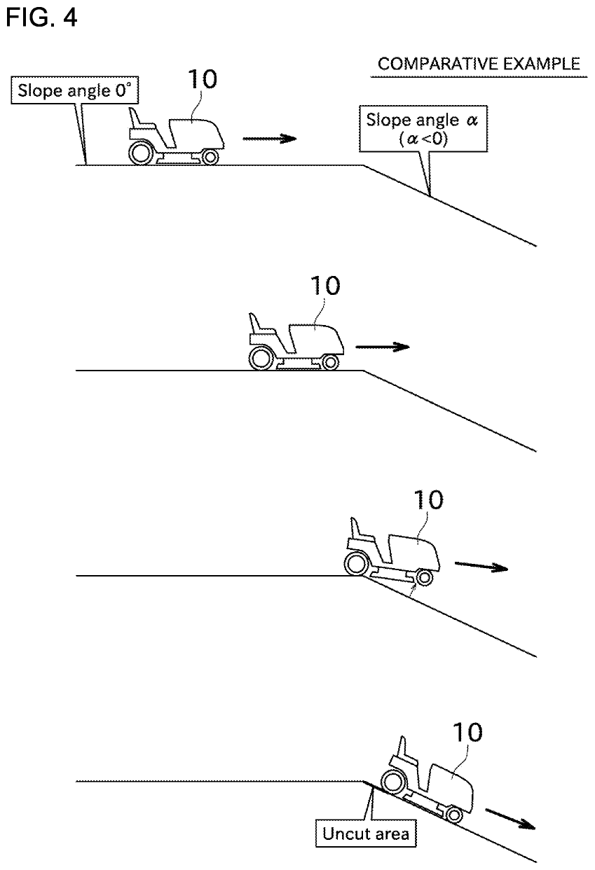

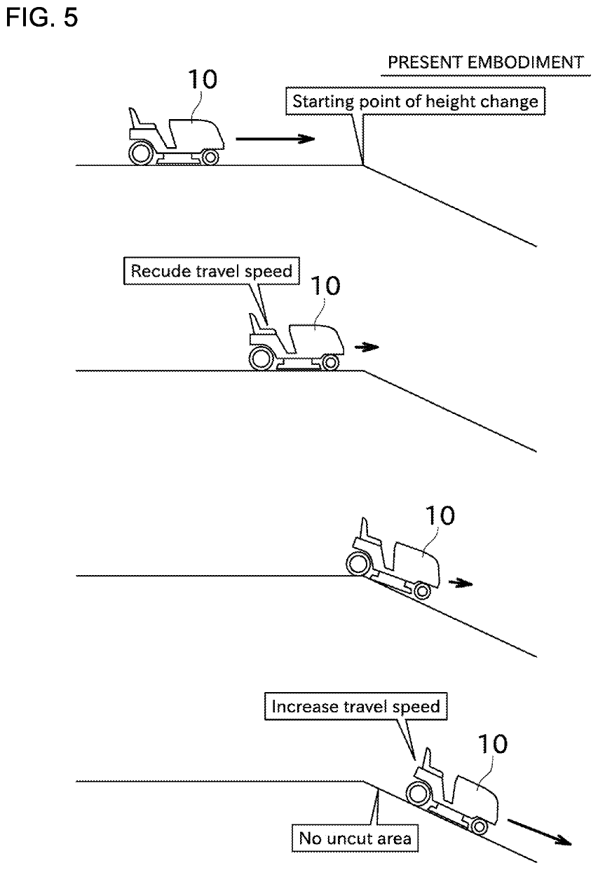

Firstly, with reference to FIG. 4 and FIG. 5, the speed change control that is performed when the height of the lawn in front of the lawn mower 10 is lower than the height at with the lawn mower 10 is currently located will be described below. FIG. 4 and FIG. 5 show the lawn mower 10 travelling from a horizontal area where the slope angle is 0 degree to a downward sloping area where the slope angle is negative. In the present specification, the slope angle of the horizontal area is defined as 0 degree, the slope angle of the upward sloping area is defined as positive, and the slope angle of the downward sloping area is defined as negative.

In a comparative example shown in FIG. 4, the travel speed of the lawn mower 10 is constant. In this case, when the travel speed is relatively high, the lawn mower 10 could lift off the ground at a time when the lawn mower 10 reaches the downward sloping area. As a result, an uncut area is apt to occur at a part of the downward sloping area. On the other hand, when the lawn mower 10 is travelling at a low speed, the lawn mower 10 is less likely to lift off the ground. However, in this case, it takes more time for the lawn mower 10 mow the entire area.

In contrast, in the present embodiment that is shown in FIG. 5, the controller 21 changes the travel speed of the lawn mower 10 according to its position. In particular, the controller 21 changes the travel speed of the lawn mower 10 based on the positional relationship with a starting point of the height change. The starting point of the height change is a point where the height begins to change. For example, a boundary between a horizontal area and a sloping area, a boundary between a gently sloping area and a steeply sloping area, and a starting point of a concave area or a convex area are the starting points of the height change. In the case where the slope angle of the ground gradually changes, for example, a point where the degree of change in the slope angle exceeds a threshold can be defined as the starting point of the height change. In the example shown in FIG. 5, specifically, the controller 21 reduces the travel speed of the lawn mower 10 from a relatively high speed before reaching the starting point of the height change between the horizontal area and the downward sloping area. As a result, the travel speed of the lawn mower 10 when the lawn mower 10 reaches the downward sloping area becomes low. Therefore, the lawn mower 10 is less likely to lift off the ground. As a result, an uncut area is less likely to occur. Furthermore, the controller 21 increases the travel speed of the lawn mower 10 after the lawn mower 10 passes the starting point of the height change. This allows the average of the travel speed of the lawn mower 10 to be higher than that when the lawn mower 10 travels at a low and constant speed so that the time required to mow the entire lawn can be shortened. Thus, the present embodiment prevents an uncut area occurring and prevents the time to mow the lawn becoming too long at the same time.

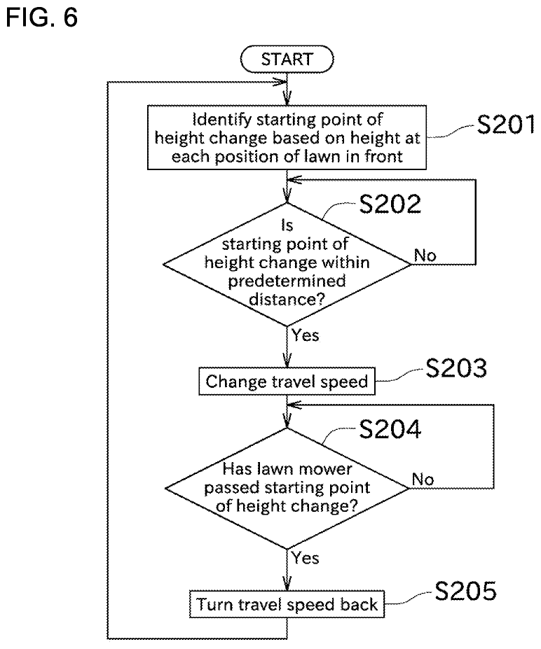

Specifically, the controller 21 performs the processes according to the flowchart shown in FIG. 6. Firstly, the controller 21 identifies the starting point of the height change based on the height at each position of the lawn in front (S201). Since the controller 21 has received the information that indicates the height at each position of the lawn in step S103, the starting point of the height change can be identified based on this information.

Next, the controller 21 determines whether the starting point of the height change is within a predetermined distance from the lawn mower 10 or not (S202). This process is necessary to change the travel speed of the lawn mower 10 before reaching the starting point of the height change. The controller 21 calculates the current distance from the lawn mower 10 to the starting point of the height change based on the information that indicates the height at each position of the lawn in front of the lawn mower 10 and compares the current distance and the predetermined distance. “The predetermined distance” used in this process may be a fixed value obtained experimentally, or may be a value calculated based on the current travel speed, the target travel speed and the like of the lawn mower 10.

If the controller 21 determines that the starting point of the height change is within the predetermined distance, it controls the drive source 12 in order to change the travel speed of the lawn mower 10 (S203). In the example shown in FIG. 4 and FIG. 5, a target travel speed is set so that the travel speed of the lawn mower 10 decreases to achieve it. The target travel speed may be a fixed value, or the target travel speed may be calculated according to the degree of the height change. When calculating the target travel speed, it is preferable to lower the target travel speed as the degree of the height change gets high.

Then, the controller 21 determines whether the lawn mower 10 has passed the starting point of the height change or not (S204). The controller 21 determines whether the starting point of the height change identified in step S201 is present based on the information that indicates the height at each position of the lawn in front of the lawn mower 10. If the starting point of the height change cannot be detected, the controller 21 determines that the lawn mower 10 has passed the starting point of the height change. This determination method is disclosed just as an example and the following method may be used. That is, when the starting point of the height change is identified in step S201, the absolute position of the starting point of the height change is identified based on the absolute position of the lawn mower 10 detected by the position sensor 23 and the distance between the lawn mower 10 and the starting point of the height change. The controller 21 compares the absolute position of the lawn mower 10 detected by the position sensor 23 with the absolute position of the starting point of the height change to determine whether the lawn mower 10 has passed the starting point of the height change or not.

When the controller 21 determines that the lawn mower 10 has passed the starting point of the height change, it controls the drive source 12 in order to turn the travel speed of the lawn mower 10 back (S205). In the example shown in FIG. 4 and FIG. 5, a target travel speed is set so that the travel speed of the lawn mower 10 increases to achieve it.

By performing the control described above, an uncut area will be less likely to occur and the efficiency of the operation will be high. Particularly, the effect of preventing the occurrence of the uncut area is achieved by the process of lowering the travel speed before reaching the starting point of the height change. Therefore, this effect cannot be achieved simply by changing the travel speed based on the current vertical orientation of the lawn mower 10 or the like.

Although the case where the lawn mower 10 travels from the horizontal area to the downward sloping area has been described above with reference to the example shown in FIG. 4 and FIG. 5, the same problem exists in a case where the lawn mower 10 travels from an upward sloping area to a horizontal area and the present embodiment can achieve the same effect in this case. In addition, the same problem exists in a case where the lawn mower 10 travels from a gentle downward sloping area to a steep downward sloping area and the present embodiment can achieve the same effect in this case. In other words, in every case where the lawn mower 10 passes a point where the slope angle of the lawn begins to decrease, the same problem exists and the present embodiment can achieve the same effect to this problem. The same problem exists in a case where the lawn is not sloping but there is a difference in level on the lawn and the present embodiment can achieve the same effect to this problem.

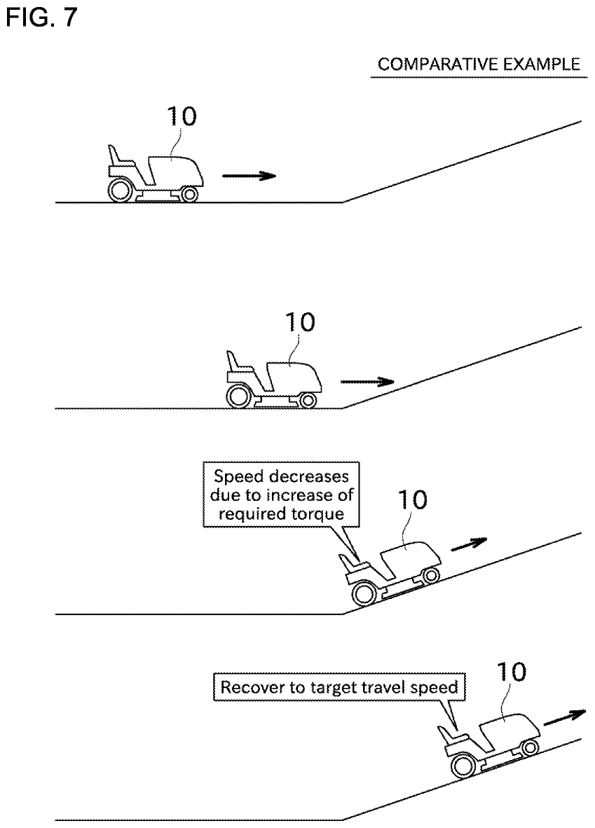

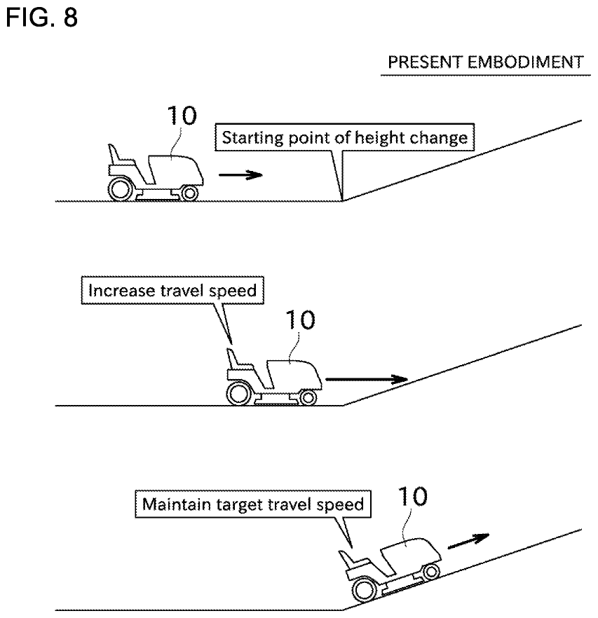

Then, with reference to FIG. 6 through FIG. 8, the speed change control performed when the height of the lawn in front of the lawn mower 10 is higher will be described below. FIG. 7 and FIG. 8 shows the lawn mower 10 travelling from a horizontal area where the slope angel is 0 degree to an upward sloping area where the slope angle is positive.

In a comparative example shown in FIG. 7, the lawn mower 10 is controlled so that it travels at a target travel speed. The target travel speed is constant. As the lawn mower 10 reaches the upward sloping area, the torque required to run the lawn mower 10 increases. As a result, the travel speed of the lawn mower 10 temporarily decreases. Since the lawn mower 10 is controlled so that it travels at the target travel speed, this control turns the travel speed of the lawn mower 10 back. In the comparative example shown in FIG. 7, the efficiency of the operation decreases because the travel speed decreases in an area where it does not need to decrease.

In contrast, in the present embodiment shown in FIG. 8, the controller 21 increases the travel speed of the lawn mower 10 before reaching the starting point of the height change between the horizontal area and the upward sloping area. As a result, the travel speed of the lawn mower 10 is maintained at the target travel speed or does not deviate much from the target travel speed even after reaching the upward sloping area. Therefore, a decrease in the efficiency of the operation due to the decrease in the travel speed of the lawn mower 10 is less likely to occur.

Specifically, the controller 21 performs the processes according to the flowchart shown in FIG. 6. Since this flowchart has already been described above, only the differences from those shown in FIG. 4 and FIG. 5 will be described below.

In the example shown in FIG. 7 and FIG. 8, in step S203, the target travel speed is set so that the travel speed of the lawn mower 10 increases to achieve it. The target travel speed may be a fixed value, or it may be calculated according to the degree of the height change. When calculating the target travel speed, it is preferable to set it higher as the degree of the height change gets high.

In the example shown in FIG. 7 and FIG. 8, in step S205, the controller 21 controls the drive source 12 in order to turn the travel speed of the lawn mower 10 back when it determined that the lawn mower 10 has passed the starting point of the height change (S205). Since it cannot be determined in advance whether the travel speed of the lawn mower 10 after it reaches the upward sloping area is above or below the target travel speed, the controller 21 changes the travel speed of the lawn mower 10 by controlling the drive source 12 in order to make the difference between the current travel speed of the lawn mower 10 and the target travel speed close to zero.

By performing the control described above, the entire operating time can be reduced. In addition, the quality of the operation of lawn mowing can be higher than when the travel speed is maintained excessively high. This effect is particularly achieved by the process of increasing the travel speed before the lawn mower 10 reaches the starting point of the height change. Therefore, this effect cannot be achieved simply by changing the travel speed based on the current vertical orientation of the lawn mower 10 or the like.

Although the case where the lawn mower 10 travels from the horizontal area to the upward sloping area has been described above with reference to the example shown in FIG. 7 and FIG. 8, the same problem exists in a case where the lawn mower 10 travels from a downward sloping area to a horizontal area and the present embodiment can achieve the same effect in this case. In other words, in every case where the lawn mower 10 passes a point where the slope angel of the lawn begins to increase, the same problem exists and the present embodiment can achieve the same effect to this problem.

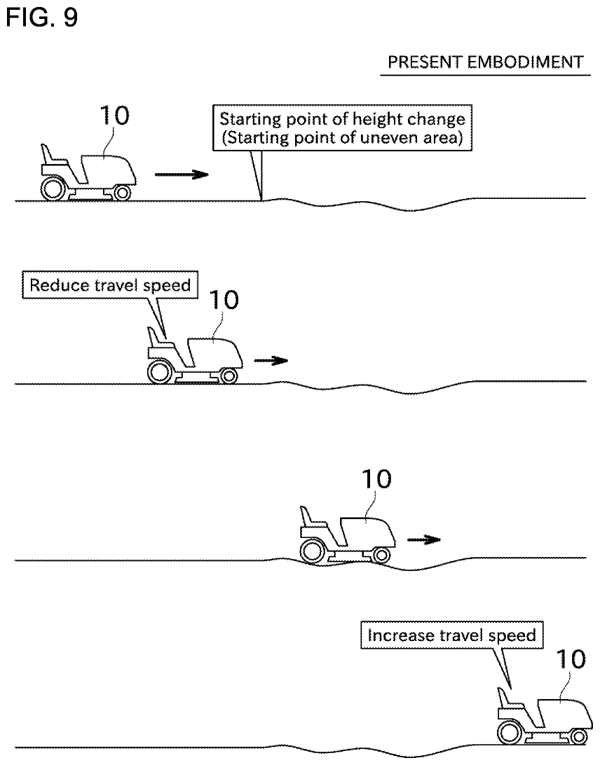

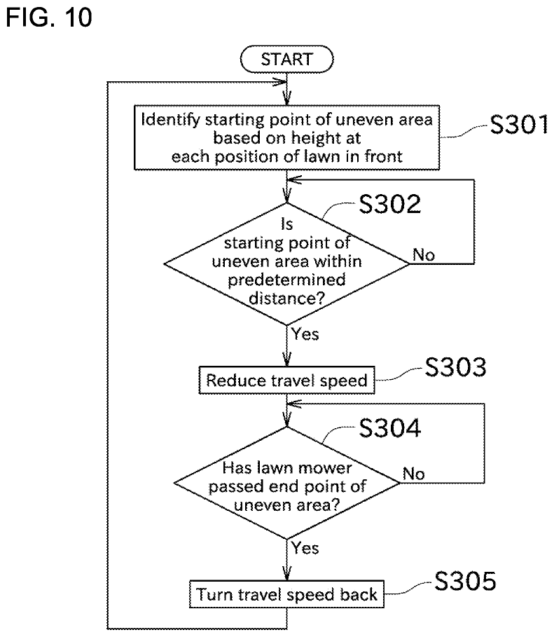

Then, with reference to FIG. 9 and FIG. 10, the process performed when there is an uneven area in front of the lawn mower 10 will be described below.

As shown in FIG. 9, the lawn may contain an uneven area that includes concave areas and convex areas side by side. As the lawn mower 10 travels over the uneven area, the lawn mower 10 may lift off the ground as described or the posture of the lawn mower 10 may become unstable. To prevent the lawn mower 10 from lifting off the ground or to prevent the unstableness of posture, it is preferable to reduce the travel speed of the lawn mower 10. If the travel speed of the lawn mower 10 is changed according to the current vibration of the lawn mower 10 or the current vertical orientation of the lawn mower 10, the lawn mower 10 will travel over a portion of the uneven area at its normal travel speed. In this case, the lawn mower 10 may lift off the ground or the posture of the lawn mower 10 may become unstable as described above.

In this regard, in the present embodiment, the travel speed of the lawn mower 10 is reduced before reaching the uneven area when the uneven area is detected in front of the lawn mower 10. Then, after the lawn mower 10 passes the uneven area, the travel speed of the lawn mower 10 is turned back by increasing the travel speed of the lawn mower 10. In this manner, the lawn mower 10 travels at a lower speed when passing over the uneven area so that the lawn mower 10 is less likely to lift off the ground or the posture of the lawn mower 10 is less likely to become unstable as described above. In addition, in the present embodiment, the travel speed of the lawn mower 10 is turned back by increasing it after passing over the uneven area. This allows higher efficiency of the operation compared to the case where the lawn mower 10 travels at a low and constant speed.

Specifically, the controller 21 performs the processes according to the flowchart shown in FIG. 10. Firstly, the controller 21 identifies the starting point of the uneven area based on the height at each position of the lawn in front (S301). Since the controller 21 has received the information that indicates the height at each position of the lawn in step S103, the starting point of the uneven area can be identified based on this information.

Next, the controller 21 determines whether the starting point of the uneven area is within a predetermined distance from the lawn mower 10 or not (S302). The method of calculating the distance to the starting point of the uneven area is the same as the method of calculating the distance to the starting point of the height change, so the description thereof is omitted.

If the controller 21 determines that the starting point of the uneven area is within the predetermined distance, it controls the drive source 12 in order to reduce the travel speed of the lawn mower 10 (S303). The target travel speed while travelling over the uneven area may be a fixed value or the target travel speed may be calculated according to the degree of the height change in the uneven area. When calculating the target travel speed, it is preferable to lower the target travel speed as the degree of the height change gets high.

Then, the controller 21 determines whether the lawn mower 10 has passed the end point of the uneven area or not (S304). This process is the same as the process of determining whether the lawn mower 10 has passed the starting point of the height change, so the description thereof is omitted. If the uneven area is wide, the end point of the uneven area may be identified while traveling over the uneven area because the end point of the uneven area cannot be identified before travelling over the uneven area.

When the controller 21 determines that the lawn mower 10 has passed the end point of the uneven area, it controls the drive source 12 in order to turn the travel speed of the lawn mower 10 back by increasing it (S305).

By performing the above-described control, the travel speed while traveling over the uneven area can always be lowered, so that the lawn mower 10 is less likely to lift off the ground and the posture of the lawn mower 10 is less likely to become unstable.

The control performed for changing the travel speed of the lawn mower 10 according to the height change at each position of the lawn in front of the lawn mower 10 described above is disclosure just as an example. It is not limited to the above control and it can be modified as follows, for example.

For example, if the right wheel and the left wheel travels at different height, the posture of the lawn mower 10 can easily become unstable. Therefore, the travel speed of the lawn mower 10 may be reduced before reaching such an area and may be increased to turn the travel speed of the lawn mower 10 back after passing through such an area.

When changing the travel speed at the starting point of the height change, the travel speed may be changed gradually, by tailing, for example, instead of changing the travel speed rapidly. This reduces the shocks caused due to the rapid change in speed and prevents the grass left uncut or a decrease in the quality of the operation of lawn mowing due to the rapid change in speed.

For example, when the lawn mower 10 travels to a sloping area from a horizontal area, the amount of change in the slope angle at the starting point of the height change may be detected. In this case, the travel speed of the lawn mower 10 when passing the starting point of the height change may be determined according to the amount of change in the slope angle. For example, if the amount of change in the slope angle is large, the travel speed of the lawn mower 10 when passing the starting point of the height change may be determined lower compared to the case where the slope angle is small.

While traveling on the downward sloping area, travel control may be performed to prevent an excessive increase in the travel speed. When leaving the downward sloping area and entering the horizontal area, travel control may be performed at the starting point of the height change, which is a boundary between them, to prevent a decrease in the travel speed. For example, the travel speed may be increased before reaching the starting point of the height change.

Instead of changing the travel speed before reaching the starting point of the height change, the travel speed may be changed at a time when the lawn mower 10 passed the starting point of the height change or after the time. In an area where the slope angle changes gradually, the travel speed may be changed according to the height of the lawn or the degree of the slope. In other words, control other than those describe above may be performed as long as it changes the travel speed based on the height at each position of the lawn. Values to be changed based on the height at each position of the lawn are not limited to the travel speed of the lawn mower 10 and the rotational speed of the mower blade as described above. For example, the output of the drive source 12, the torque, or the amount of the grass to be cut may be changed based on the height at each position of the lawn.

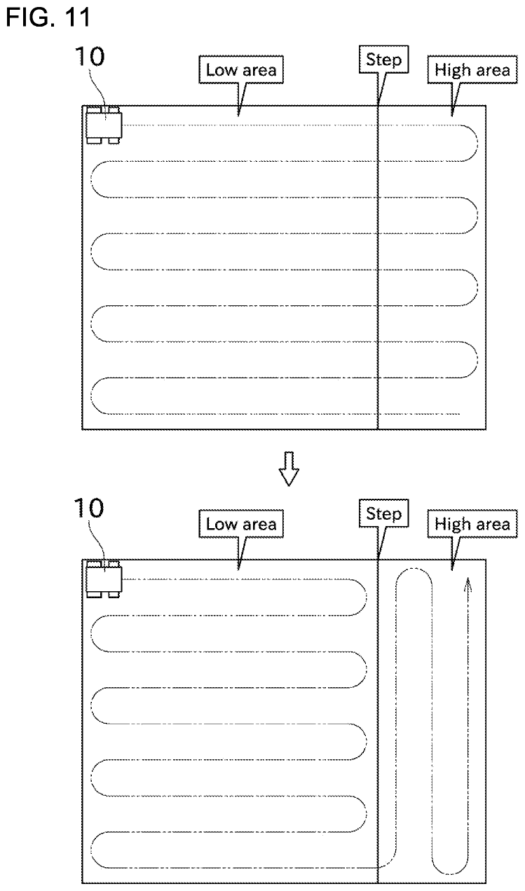

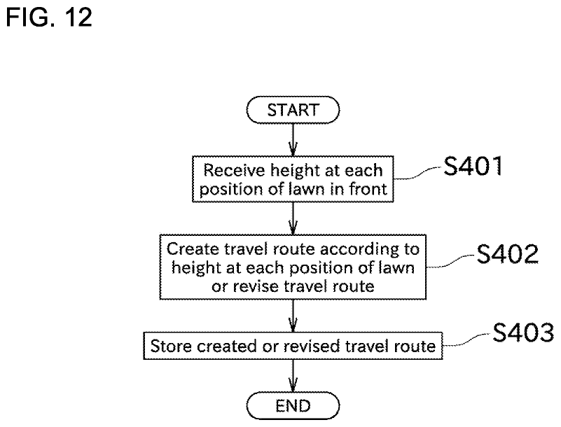

Then, with reference to FIG. 11 and FIG. 12, the process performed to create or revise a travel route according to the height at each position of the lawn will be described below.

Firstly, the travel route will be described below. The travel route is a route that the lawn mower 10 travels to mow the lawn. The controller 21 drives the lawn mower 10 so that it travels autonomously along the travel route. Alternatively, the lawn mower 10 may present the travel route to the operator and the operator may drive the lawn mower 10 along the travel route.

In principle, the travel route is set before the start of mowing. Specifically, an administrator performs a predetermined operation on the lawn mower 10 or the laptop PC 40 to display the operation area, which is an area to be mowed, on the display apparatus 26 or the laptop PC 40. The administrator then inputs information about where a start and a goal of the route is, the cutting width or the like and the lawn mower 10 or the laptop PC creates the travel route. The administrator may also set the travel route manually. The travel route may be created after the start of mowing and may be revised after the start of mowing. The lawn mower 10 of the present embodiment receives the information about the height at each position of the lawn in front and creates or revises the travel route based on that information.

In FIG. 11, the travel route is shown in a dash double-dot line. The upper half of FIG. 11 shows a predefined travel route. The lawn shown in FIG. 11 includes a step and low and high areas exist with the step as a boundary. In the predefined travel route, the travel speed is reduced many times because the lawn mower 10 passes through the step frequently. Therefore, the efficiency of the operation when following this travel route is low.

The lower half of FIG. 11 shows a travel route revised after the start of mowing. The lawn mower 10 can determine the presence of a step in the lawn based on the height at each position of the lawn. Therefore, in order to reduce the number of times it passes through the step, the lawn mower 10 initially mows the low area at once and then moves to the high area and mows the high area collectively. This reduces the number of times the lawn mower 10 passes through the step, thus reducing the number of times the travel speed is reduced. As a result, the efficiency of the operation can be improved.

Specifically, the controller 21 performs the processes according to the flowchart shown in FIG. 12. Firstly, the lawn mower 10 receives the height at each position of the lawn in front as described above (S401).

Next, the controller 21 creates a travel route according to the height at each position of the lawn or revises a travel route (S402). In the example shown in FIG. 11, the travel route is revised so that the number of times the lawn mower 10 passes through the step is reduced. However, this is disclosed just as an example and following processes may be performed. For example, if these is an area with a large degree of unevenness, a travel route may be created or revised so that the lawn mower 10 mows the lawn avoiding that area. In this case, the area with a large degree of unevenness is mowed manually or with another lawn mower, for example.

Alternatively, the controller 21 may retrieve travel routes at the same lawn that were previously travelled from the laptop PC 40 or a server to create the travel route based on that previous travel routes. In this case, if it is possible to obtain the operating times corresponding to the previous travel routes, the travel route that required the shortest operating time may be employed. Instead of the previous travel routes, the controller 21 may retrieve a travel route that was travelled by another lawn mower 10 from the laptop PC or the server to create the travel route based on that travel route travelled by the other lawn mower 10.

Then, the controller 21 stores the created or revised travel route in the storage of the controller 21 or the like (S403). The controller 21 then drives the lawn mower 10 so that it mows the lawn travelling along the created or revised travel route.

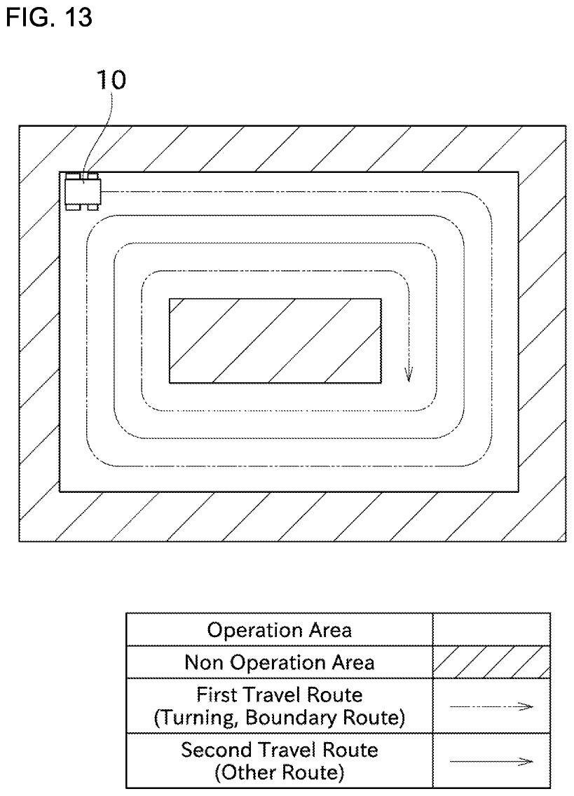

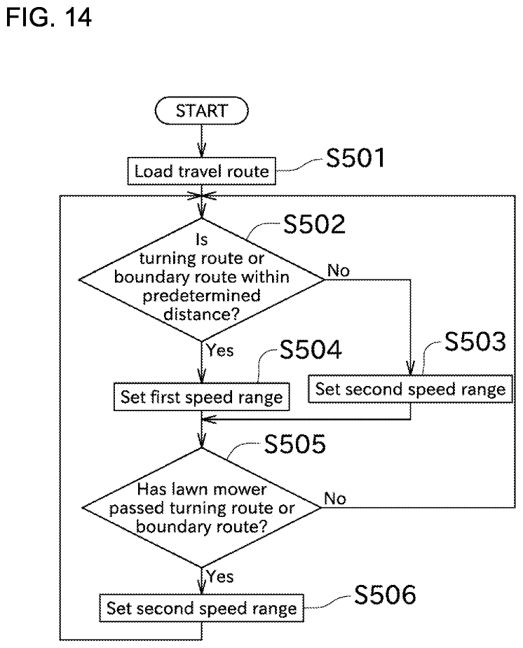

Then, with reference to FIG. 13 and FIG. 14, the process performed to change the travel speed of the lawn mower 10 according to a type of the travel route will be described below.

FIG. 13 shows an operation area, a non-operation area, and a travel route. The travel route is shown divided into a first travel route and a second travel route. The first travel route is a turning route or a boundary route. The turning route is a travel route along which the lawn mower 10 takes a turn. On the turning route, it is preferable to run the lawn mower 10 at a low speed because the posture of the lawn mower 10 easily becomes unbalanced. The boundary route is a travel route that is set at and near the boundary between the operation area and non-operation area. Since the owner of the non-operation area may differ from that of the operation area, it is necessary to avoid entering the non-operation area. Therefore, it is preferable to run the lawn mower 10 at a low speed on the boundary route. The second travel route is a travel route other than the turning route and the boundary route. On the second travel route, it is preferable to run the lawn mower 10 at a high speed in order to enhance the efficiency of the operation, since there is no need to reduce the travel speed as described above.

This classification is disclosed just as an example and the first travel route may include an uneven or sloping route. If the first travel route includes a sloping route, the travel speed may be determined based on the magnitude of the slope angle. For example, the travel speed in an area where the slope angle is smaller than a threshold may be determined higher than the travel speed in an area where the slope angle is larger than the threshold. In addition, any one of the turning route and the boundary route may be excluded from the first travel route. Further, the second travel route may be initially defined and a route other than the second travel route may be defined as the first travel route. In this case, the second travel route preferably is created in an area with the slope angle of 0 degree, i.e. an area on level ground. The definition of the second travel route may also include the condition that it is straight in addition to being created on level ground.

In the present embodiment, the lawn mower 10 is set to the first mode in the first travel route and is set to the second mode in the second travel route. This allows high efficiency of the operation while accurately avoiding posture changes of the lawn mower 10 or entering into non-operation areas.

Specifically, the controller 21 performs the processes according to the flowchart shown in FIG. 14. Firstly, the lawn mower 10 loads a preset travel route (S501). The travel route may be created after the start of mowing.

Next, the controller 21 determines whether the turning route or the boundary route is within a predetermined distance from the lawn mower 10 or not (S502). The absolute location of the turning route or the boundary route can be identified based on the loaded travel route. The current absolute position of the lawn mower 10 can be identified based on the results of the detection made by the position sensor 23. Thus, the controller 21 can identify the distance measured along the travel route from the current absolute position of the lawn mower 10 to the absolute location of the turning route or the boundary route. The controller 21 compares this identified distance with the predetermined distance to make the decision in step S502. The predetermined distance may be an experimentally determined value.

If the controller 21 determines that a distance to the turning route or the boundary route exceeds the predetermined distance, it sets the second speed range (S503). Thereafter, the controller 21 repeats the determination of step S502. If the controller 21 determines that the turning route or the boundary route is within the predetermined distance, it sets the first speed range (S504). This allows the lawn mower 10 to travel the turning route or the boundary route at a low speed.

The controller 21 then determines whether the lawn mower 10 has passed the turning route or the boundary route (S505), and if it determines that the lawn mower 10 has passed the turning route or the boundary route, it sets the second speed range again to increase the travel speed of the lawn mower 10 (S506).

Performing the above processes allows the lawn mower 10 to travel the turning route or the boundary route at a low speed while travelling other routes at a high speed. As a result, the high efficiency of the operation can be achieved while accurately avoiding posture changes of the lawn mower 10 or entering into non-operation areas.

(Feature 1) As described above, the lawn mower 10 of the present embodiment travels on a lawn and cuts grass. The lawn mower 10 includes the drive source 12 and the controller 21. The drive source 12 generates power for the lawn mower 10 to travel. The controller 21 receives the height at each position of the lawn from a sensor that detects the height at each position of the lawn or from a memory (the storage of the controller 21, the laptop PC 40, or the server) that stores the height at each position of the lawn and controls the drive source 12 based on the height change in the lawn in front in a travel direction to change the travel speed. A travel control method is thus achieved. Instead of the height at each position of the lawn in front of the lawn mower 10, information about the surroundings of the lawn mower 10 may be used, as described below.

This allows the travel speed to be changed based on the height change in the lawn, so that the lawn mower 10 can mow the lawn while travelling at different travel speeds according to the height change in the lawn. Therefore, lawn mowing appropriate for the lawn to be mowed can be achieved. For example, compared to the case where the lawn mower 10 travels at a constant speed regardless of the height changes in the lawn, the travel speed can be prevented from becoming too high or too low due to the height changes in the lawn. Preventing the travel speed from becoming too high or too low makes it easier, for example, both to shorten the operating time and to prevent the quality of the work from decreasing at the same time.

(Feature 2) In the lawn mower 10 of the present embodiment, the controller 21 changes the travel speed before the lawn mower 10 reaches the starting point of the height change in the lawn.

This allows the travel speed to be changed before an effect of the height change occurs, thus reducing the impact of the height change on lawn mowing.

(Feature 3) In the lawn mower 10 of the present embodiment, the controller 21 reduces the travel speed before the lawn mower 10 reaches the starting point of the height change in the lawn and increases the travel speed after the lawn mower 10 passes the starting point.

This reduces the impact of the position at which the height of the lawn begins to change on lawn mowing.

(Feature 4) In the lawn mower 10 of the present embodiment, the controller 21 reduces the travel speed before the lawn mower 10 reaches a point where the slope angle of the lawn begins to decrease and increases the travel speed after the lawn mower 10 passes the point.

This reduces the degree of how the lawn mower 10 lifts off the ground when passing the point where the slope angle begins to decrease and enhances the efficiency of the operation by increasing the travel speed of the lawn mower 10 after that.

(Feature 5) In the lawn mower 10 of the present embodiment, the controller 21 switches the first mode and the second mode. The travel speed is set higher in the second mode compared to the first mode.

This allows the operation according to the purpose to be performed by selecting the first mode when the quality of the operation takes priority and selecting the second mode when the speed of the operation takes priority.

(Feature 6) In the lawn mower 10 of the present embodiment, the controller 21 transmits information about which of the first mode or the second mode is currently selected to the display apparatus 26 and displays the mode currently selected on the display apparatus 26.

This allows the operator to know the current mode at a glance.

(Feature 7) In the lawn mower 10 of the present embodiment, the controller 21 switches the first speed range and the second speed range that includes a speed higher than a maximum speed in the first speed range and does not include a speed lower than a minimum speed in the first speed range. The controller 21 sets the second speed range when the lawn in front in the travel direction is on level ground.

This allows higher efficiency of the operation by setting the second speed range, since problems are less likely to occur in the area on level ground even if the travel speed is set high.

(Feature 8) In the lawn mower 10 of the present embodiment, the controller 21 switches the first speed range and the second speed range that includes a speed higher than a maximum speed in the first speed range and does not include a speed lower than a minimum speed in the first speed range. The controller 21 sets the first speed range when the lawn mower 10 is located at the boundary between the operation area and another area.

This allows the careful operation by setting the first speed range at the boundary of the operation area.

(Feature 9) The lawn mower 10 of the present embodiment includes a rotary mower blade. The controller 21 changes the rotational speed of the mower blade according to the travel speed.

This allows the quality of the operation to be maintained because the rotational speed of the mower blade is increased when the travel speed is increased.

(Feature 10) In the lawn mower 10 of the present embodiment, the controller 21 creates or revises the travel route based on the received height at each position of the lawn.

This allows an appropriate travel route according to the height of the lawn to be used.

(Feature 11) In the lawn mower 10 of the present embodiment, the drive source 12 is an engine that includes an electronically controlled fuel injection apparatus or is an electric motor.

When an engine that includes an electronically controlled fuel injection apparatus is used, recovery when the load increases is fast. When an electric motor is used, the torque and the rotational speed can be adjusted with high accuracy. Therefore, these drive sources are particularly effective in situations where the load change is likely to occur.

Features 1 to 11 described above can be combined as appropriate as long as no contradiction arises. For example, feature N (N=1, 2, . . . , 11) can be combined with at least one of features 1 to N−1 as appropriate.

While the preferred embodiment of the present application has been described above, the configurations explained above may be modified, for example, as follows.

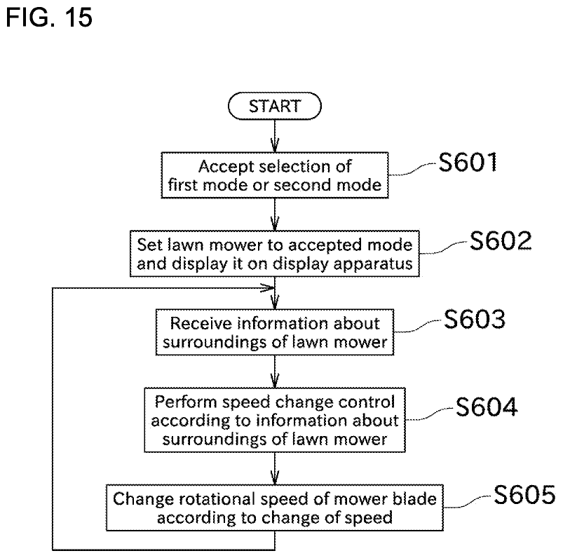

The flowcharts shown in the above embodiment are disclosed just as examples and some processes may be omitted, some contents of processes may be changed, and new processes may be added. For example, the processes shown in FIG. 2 may be replaced with processes shown in FIG. 15. In processes in step S603 and S604 shown in FIG. 15, “information about the surroundings of the lawn mower” is used instead of “the height at each position of the lawn in front” used in step S103 and S104 shown in FIG. 2. The information about the surroundings of the lawn mower 10 includes not only the height at each position of the lawn in front but also other information. For example, the information about the surroundings of the lawn mower 10 includes condition of grass around the lawn mower 10. The condition of the grass can be detected by using, for example, a camera. The controller 21 reduces the travel speed of the lawn mower 10 in order to reduce the amount of the grass left uncut when it determines that the amount of the grass is large. Since the rest of the processes are the same as the flowchart in FIG. 2, the description thereof is omitted.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1-14. (canceled)

15. A lawn mower that travels on a lawn and cuts grass, comprising:
a drive source generating power for the lawn mower to travel; and
a controller receiving a height at each position of the lawn from a sensor that detects the height at each position of the lawn or from a memory that stores the height at each position of the lawn, the controller controlling the drive source based on a height change in the lawn in front in a travel direction to change a travel speed.

16. The lawn mower according to claim 15, wherein the controller changes the travel speed before the lawn mower reaches a starting point of the height change in the lawn.

17. The lawn mower according to claim 15, wherein the controller reduces the travel speed before the lawn mower reaches a starting point of the height change in the lawn and increases the travel speed after the lawn mower passes the starting point.

18. The lawn mower according to claim 15, wherein the controller reduces the travel speed before the lawn mower reaches a point where a slope angle of the lawn begins to decrease and increases the travel speed after the lawn mower passes the point.

19. The lawn mower according to claim 15, wherein the controller switches a first mode and a second mode and wherein the travel speed is set higher in the second mode compared to the first mode.

20. The lawn mower according to claim 19, wherein the controller transmits information about which of the first mode and the second mode is currently selected to a display apparatus and displays the mode currently selected on the display apparatus.

21. The lawn mower according to claim 15, wherein the controller switches a first speed range and a second speed range that includes a speed higher than a maximum speed in the first speed range and does not include a speed lower than a minimum speed in the first speed range, and wherein the controller sets the second speed range when the lawn in front in the travel direction is on level ground.

22. The lawn mower according to claim 15, wherein the controller switches a first speed range and a second speed range that includes a speed higher than a maximum speed in the first speed range and does not include a speed lower than a minimum speed in the first speed range, and wherein the controller sets the first speed range when the lawn mower is located at a boundary between an operation area and another area.

23. The lawn mower according to claim 15, comprising
a mower blade which is rotary,
wherein the controller changes a rotational speed of the mower blade according to the travel speed.

24. The lawn mower according to claim 15, wherein the controller creates or revises a travel route based on the received height at each position of the lawn.

25. The lawn mower according to claim 15, wherein the drive source is an engine that includes an electronically controlled fuel injection apparatus or is an electric motor.

26. A lawn mower that travels on a lawn and cuts grass, comprising:
a drive source generating power for the lawn mower to travel; and
a controller controlling the drive source and sets a first speed range or a second speed range that includes a speed higher than a maximum speed in the first speed range and does not include a speed lower than a minimum speed in the first speed range based on information about surroundings of the lawn mower received from a sensor or a memory.

27. A travel control method, comprising:
receiving information about surroundings of a lawn mower from a sensor or a memory;
setting a first speed range or a second speed range that includes a speed higher than a maximum speed in the first speed range and does not include a speed lower than a minimum speed in the first speed range based on the information about the surroundings of the lawn mower received; and
controlling a drive source based on the first speed range or the second speed range set to make the lawn mower to travel.

28. The travel control method according to claim 27, wherein the information about the surroundings of the lawn mower is a height at each position of the lawn.
